(19) United States
(12) Patent Application Publication
(10) Pub. No.: US 2019/0308812 A1
(43) Pub. Date: Oct. 10, 2019

(54) A MULTI-STOREY GOODS STORAGE ARRANGEMENT, A METHOD OF OPERATING SUCH AN ARRANGMENT AND A PICKER TRANSFER CART FOR OPERATION THEREIN

(71) Applicant: LOGEVO AB, Älmhult (SE)

(72) Inventor: Bo LINDBLOM, Osby (SE)

(21) Appl. No.: 16/340,583

(22) PCT Filed: Oct. 10, 2017
(86) PCT No.: PCT/SE2017/050994

§ 371 Date: Apr. 9, 2019

(30) Foreign Application Priority Data
Oct. 14, 2016 (SE) 1651350-9

(51) Int. Cl. B65G 1/137; B65G 1/04

(52) U.S. Cl. CPC B65G 1/1375; B65G 1/0492

(57) ABSTRACT

A picker transfer cart (28) arranged to move along picking aisles (19) in a multi-storey goods storage arrangement (10) comprising a plurality of levels of storage lines (12) arranged in parallel, each storage line (12) supporting a plurality of baseboards (14) with packages (16),
transport aisles (18) extending in parallel between opposing ends of sets said storage lines (12). Each picker transfer cart (28) supports at least one picker cart (40) suspended from a top rail arrangement (30), and said picker cart (40) comprises lifting means (46) to lift a package (16) stored in said storage lines (12) and to transport lifted package to a picking aisle (19) after returning said picker cart (40) to said picker transfer cart (28). Said lifting means (46) comprises two lifting yokes (48) suspended from said picking cart (40), each of said lifting yokes (48) comprising a suction device (60) having a surface to be firmly engaged to a package (16).

### TECHNICAL FIELD

A multi-storey goods storage arrangement comprising a plurality of levels of storage lines arranged in parallel, each storage line supporting a plurality of baseboards with packages, and transport aisles extending in parallel between opposing ends of sets of said storage lines, wherein at least one baseboard transfer cart is operable along each transport aisle and a plurality of picker carts are arranged for picking packages in said storage lines and for delivering packages on conveyors.

### PRIOR ART

Multi-storey goods storage arrangements or pallet racks are used in a wide area of applications, such as conventional warehouses, storages and stores. Goods, such as packages or cases, are normally arranged on pallets that are transported in the multi-storey goods storage arrangement by different kinds of carts, carriages, shuttles and conveyors. In automated multi-storey goods storage arrangements, the carriages, shuttles and conveyors are controlled by computer systems and pick up, transport, store and deliver goods without human influence.

In some multi-storey goods storage arrangements manual picking from pallets on a picking line is used to combine different objects from different pallets into mixed pallets for delivery or packaging.

### SUMMARY OF THE INVENTION

It would be desirable to improve the process in prior art multi-storey goods storage arrangements when separate items or parcels are picked from storage lines. The multi-storey goods storage arrangement comprises a plurality of levels of storage lines arranged in parallel and transport aisles or lines extending between opposing ends of said storage lines. At least one picking aisle extends in parallel between opposing ends of sets of said storage lines and in parallel with said transport aisles.

At least one picker transfer cart is operating along each picking aisle at each level and each picker transfer cart supports a picker cart. The picker carts are suspended from the picker transfer carts and are operable from the picker transfer carts into the storage lines. The picker carts are provided with means for picking up goods stored on pallets or baseboards. After returning to the picker transfer cart and positioning the picker transfer cart above a conveyor the goods is lowered and placed on the conveyor.

The means for picking up goods comprises lifting means and a hoist. In various embodiments the means for picking up goods comprises a lifting yoke with a suction device. The picker cart comprises a locking device. The locking device will ensure that goods will remain in position on the picker cart, should the suction device be faulty.

In various embodiments the picker carts suspend from a top rail arrangement on said picker transfer cart and are moveable out from said picker transfer cart into a suspension rail arrangement in said storage lines.

In various embodiments said picker carts are provided with a cable winder. The cable of the cable winder is electrically connected to a power outlet on said picker transfer cart for providing electric power to the lifting yoke and to said locking device. Also compressed air and control signals are transferred through the cable or cables. The length of the cable extends the length of a storage line and also the distance from a top level of the multi-storey goods storage arrangement the level where the conveyor is arranged. As a result, the lifting yoke is provided with electric power and control signals during operation.

### BRIEF DESCRIPTION OF THE DRAWINGS

In order that the manner in which the above recited and other advantages and objects of the invention are obtained will be readily understood, a more particular description of the invention briefly described above will be rendered by reference to specific embodiments thereof which are illustrated in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1 is a schematic partial top view of one level of a first embodiment of a multi-storey goods storage arrangement in accordance with the invention,

FIG. 2 is a schematic side view of an embodiment of a picking aisle in a four-level multi-storey goods storage arrangement in accordance with the invention,

FIG. 3 is a schematic side view of an embodiment of a picker cart in accordance with the invention with lowered lifting means supporting a package,

FIG. 4 is a schematic front view of the picker cart shown in FIG. 3,

FIG. 5 is a schematic side view of a picker transfer cart,

FIG. 6 is a schematic top view of the picker transfer cart shown in FIG. 5,

FIG. 7 is a schematic top view of a picker cart in a position in a storage line and picker transfer cart in a position in a picking aisle, and

FIG. 8 is a more detailed top view of one embodiment of a picker cart in accordance with the invention,

### DETAILED DESCRIPTION

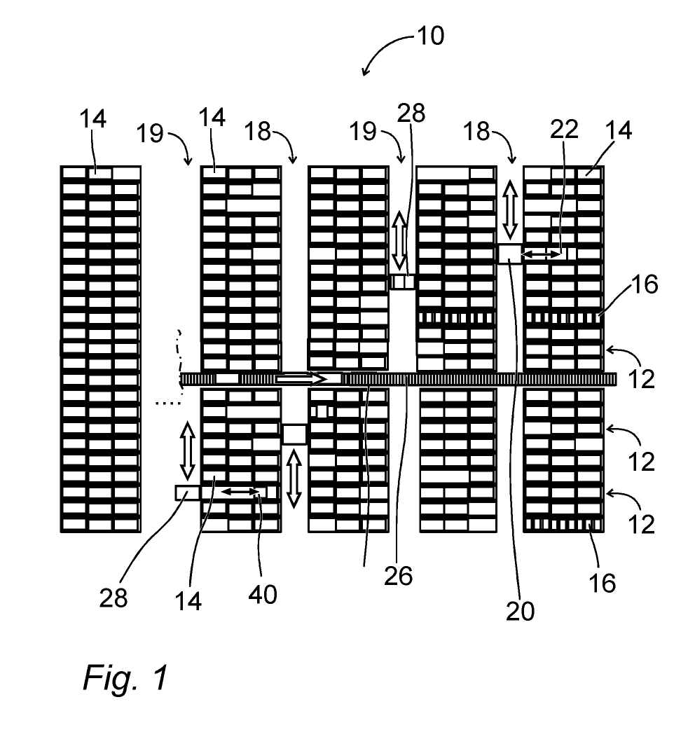

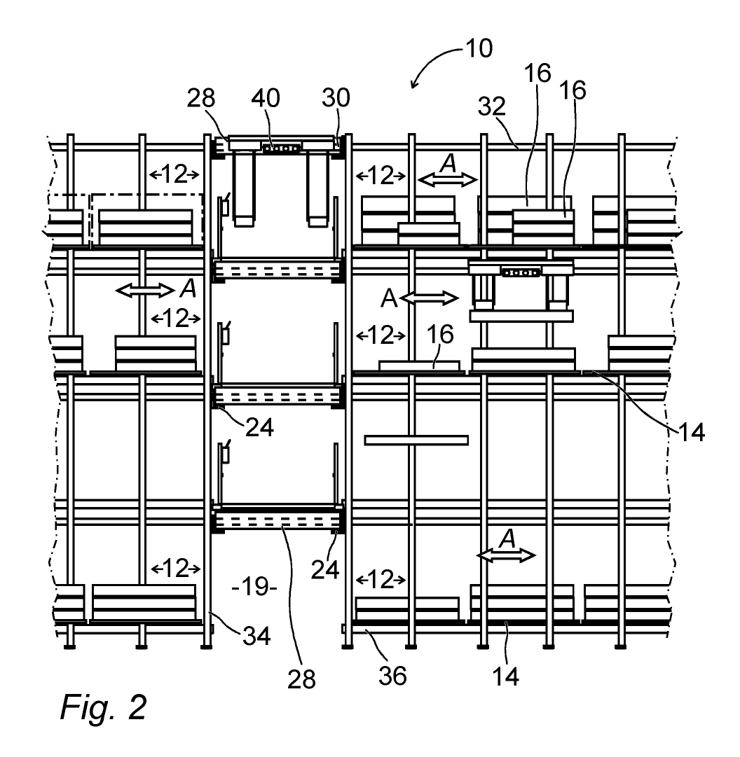

In the embodiment shown in FIG. 1 and FIG. 2 a multi-storey goods storage arrangement or pallet racking 10 comprises a plurality of levels of storage lines 12 in which pallets 14 with packages 16 are stored. The storage lines 12 extend in two opposite directions from transport lines 18 extending between opposite ends of said storage lines 12, said transport lines 18 also having a plurality of levels. Baseboard transfer carts 20 supporting a shuttle 22 operate in said transport lines 18 in a direction perpendicular to the storage lines 12. The shuttle 22 is supported in a conventional way on a rail system in a lower section of the baseboard transfer cart 20. A corresponding rail system extends along said storage lines 12 to allow said shuttle 22 to transport pallets 14 to and from selected positions along said storage lines 12.

The rail system in said storage lines also supports baseboards or pallets 14 on which packages 16 are stored. Normally each baseboard 14 in one storage line 12 supports one type of articles or packages. Packages are received to and delivered from the multi-storey goods storage arrangement through different means.

Each shuttle 22 is arranged to move away from the transfer cart 20 into said storage lines 12 carrying packages 16 on baseboards 14. The baseboards 14 can be transported along a storage line 12 to be placed at a selected position in the storage line 12. The baseboards 14 also can be picked up at a selected position by the shuttle 22 and transported to the transfer cart 20 which then will transport the picked-up pallet along the transport line to a selected new storage line.

The multi-storey goods storage arrangement basically is a pallet racking with a plurality of uprights 34 and horizontal load beams 36. The load beams 36 can be designed as or include said rail system for supporting the shuttle 22. Conventional diagonal braces and horizontal braces can also be used.

The shuttle 22 moves from the transfer cart 20 into the storage lines 12 and back carrying pallets or baseboards 14 with or without packages 16. The shuttle 22 is provided with support means that can be raised in position under a baseboard 14 and kept in a raised position during transport in the storage line 12. When packages have reached an intended position in the storage line or elsewhere the support means is lowered and the packages will rest on rails or load beams 36 or on the baseboard transfer cart 20.

The multi-storey goods storage arrangement shown in FIG. 1 and FIG. 2 comprises also picking aisles 19 in which picker transfer carts 28 operate. The picking aisles 19 extend parallel to the transport aisles 18 and are normally arranged between transport aisles 18 forming an arrangement with alternating transport aisles 18 and picking aisles 19. Picker transfer carts 28 operate back and forth in each picking aisle 19 running on rails 24. Each picker transfer cart 28 supports a picker cart 40 suspended from a top rail arrangement 30 and movable into and out of a suspension rail arrangement 32 in the storage lines 12 as indicated by arrow A.

In each transport aisle 18 at least one baseboard transfer cart 20 operates to transport baseboards 14 with packages using shuttles 22 to selected positions in the storage lines 12. In each picking aisle 19 at least one picker transfer cart 28 is arranged to pick up packages 16 in the storage lines 12 using a picker cart 40. The shuttles 22 and the picker carts 40 have an operation distance corresponding the length of a storage line 12 between a transport aisle 18 and a picking aisle 19. All baseboards 14 and packages 16, respectively, in each storage line thus can be reached and positioned correctly.

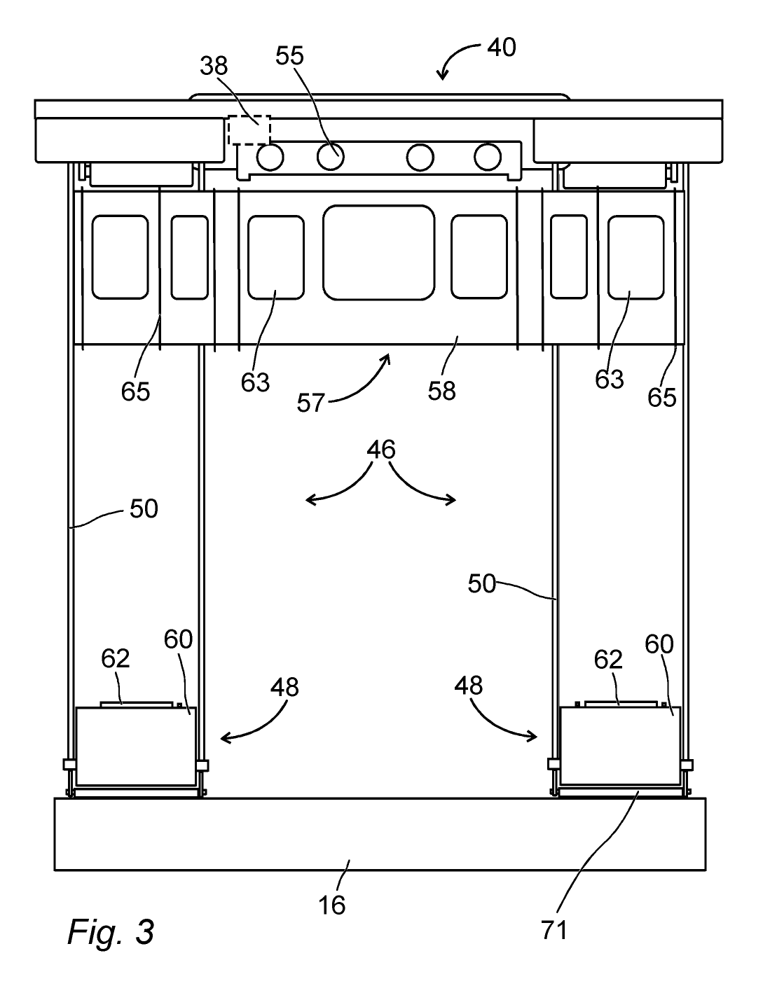

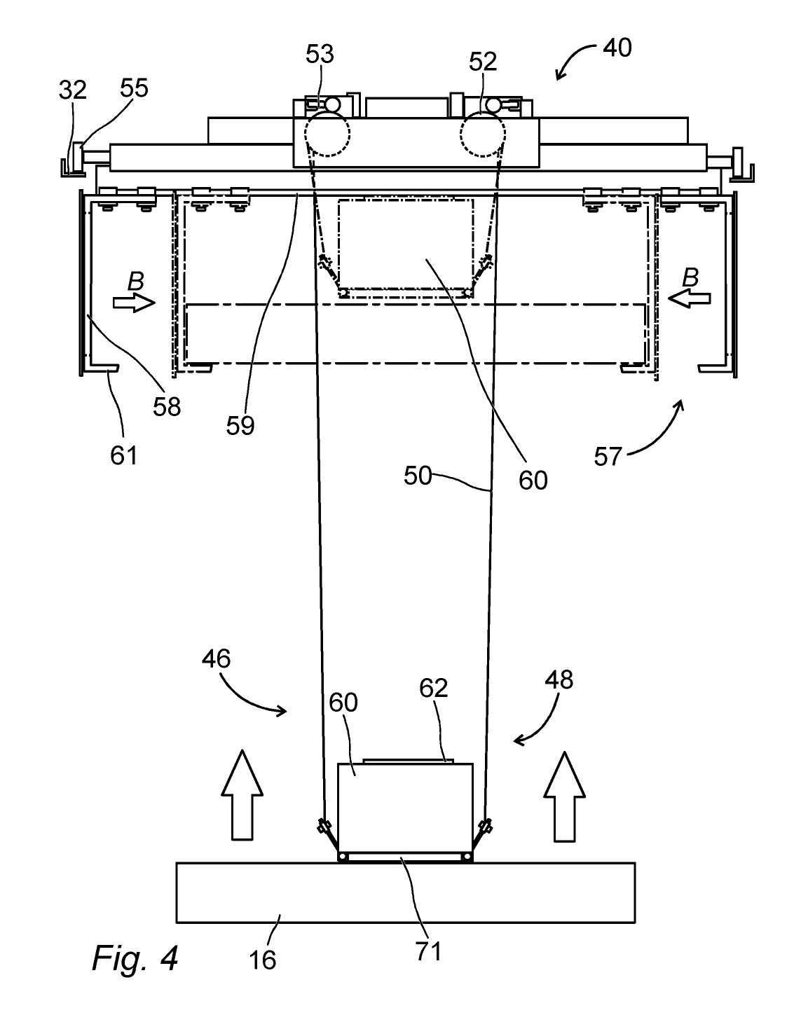

In various embodiments, such as those shown in FIG. 3 and FIG. 4, the picker cart 40 comprises lifting means 46 for lifting top packages disposed on pallets in the storage lines 12. The lifting means 46 is designed in dependence on the type of goods, packages or boxes that are stored in the storage lines 12. In the embodiment shown in FIG. 3 and FIG. 4 the lifting means 46 comprises two lifting yokes 48 suspended in hoisting belts 50.

The picker cart 40 supports the lifting means 46 comprising the lifting yoke 48 suspended in hoisting belts 50. The hoisting belts 50 are suspended from hoisting wheels 52 driven by a motor and gearbox 53. The lifting yoke 48 comprises a fan such as a suction device 60 driven by a suction motor 62.

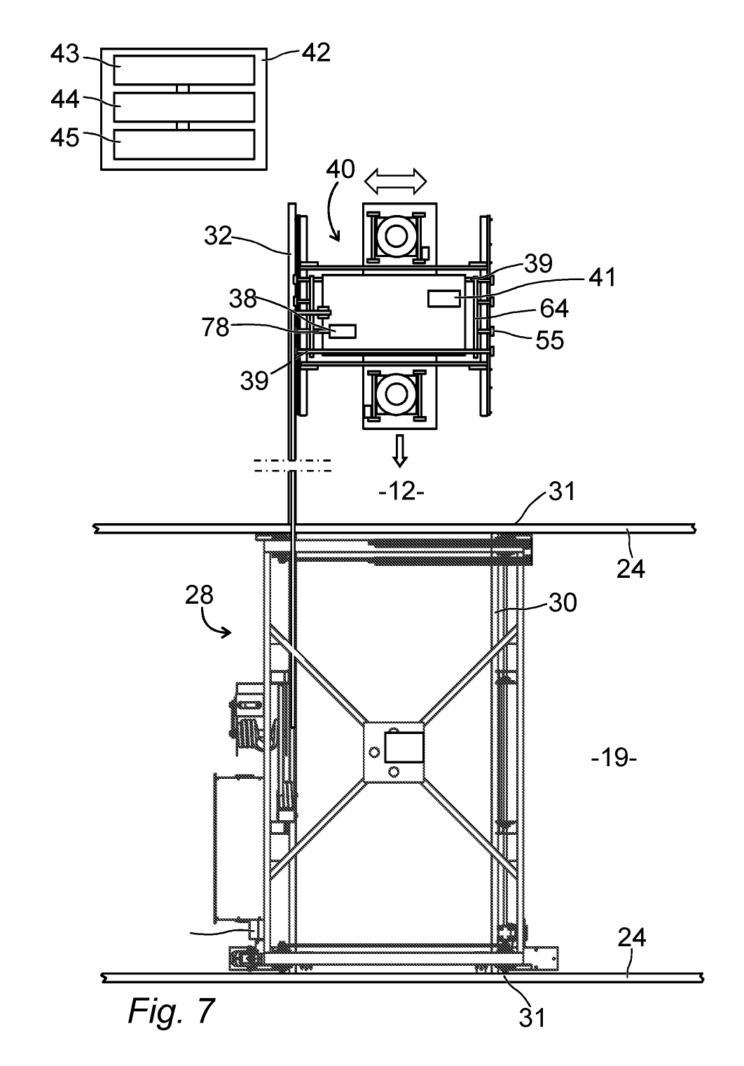

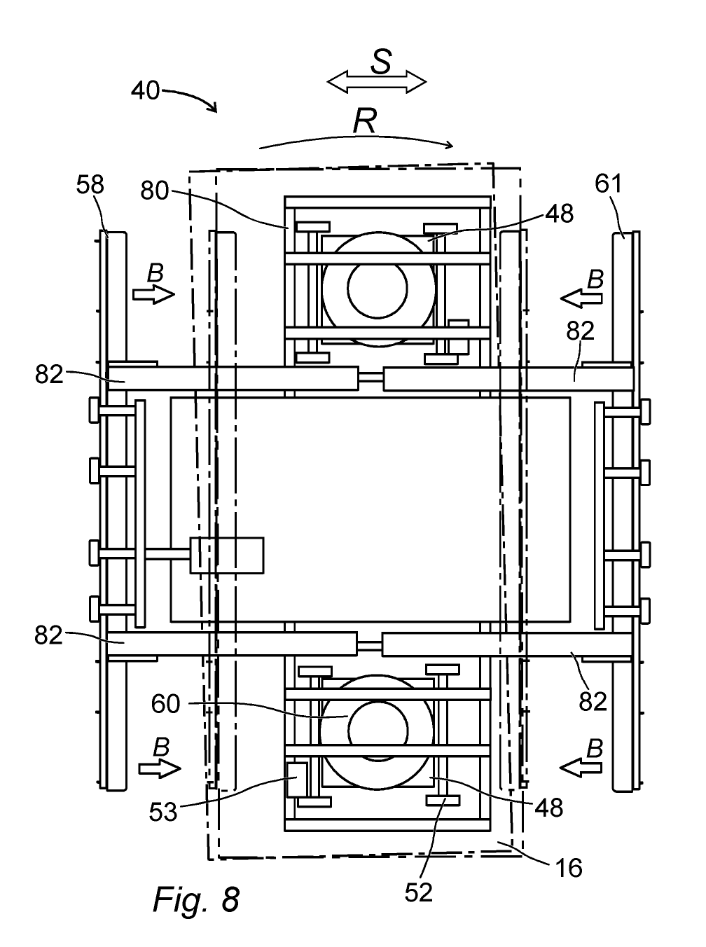

The picker cart 40 is driven by an electric motor 38, c.f. FIG. 7 and FIG. 8. The electric motor 38 and other electric equipment of the picker cart 40 can be provided with electric power from a power outlet 49, c.f. FIG. 6, on the picker transfer cart 28 through a control cable 54. The picker transfer cart 28 is powered through a conductor rail (not shown) in the rails 24.

In various embodiments the power used by the electric motor 38 and other electric equipment of the picker cart 40 is reduced and a mobile power supply comprising super capacitors or similar charge storing devices replaces the power outlet and control cable 54. In such embodiments the charge storing devices are charged when the picker cart 40 has returned to the picker transfer cart 28.

The suction device 60 and particularly the suction plate 71 are designed and arranged in dependency of the shape and weight of packages 16. Normally, one type of packages is arranged together in one or a plurality of storage lines 12. As a result, a picker cart 40 supporting a suitable suction device 60 and suction plate 71 is associated to and operates in these storage lines 12.

The picker cart 40 is provided with a locking device 57 arranged to hold a package 16 during movements of the picker cart 40. The locking device 57 is activated when a package 16 has been lifted by one or two lifting yokes 48 to a position close to a bottom side of picker cart 40. In the embodiment shown in FIG. 3 and FIG. 4 the locking device 57 comprises two rectangular plates 58 arranged on sliding members 59, c.f. FIG. 8. The plates 58 are arranged to be moved towards each other in the direction of arrow B from a starting position as shown in FIG. 4 to a closer position where a package 16 is firmly held between the plates 58. A support section 61 extends perpendicularly along a lower side edge of each plate 58. When the plates 58 have been moved to the closer position as shown with dash and dot lines in FIG. 4 a package 16 will be supported by the support sections 61 and the suction device 60 is deactivated.

It is desirable to reduce the weight of picker cart 40. The plates 58 are formed with a plurality of recesses 63 substantially reducing the weight of the plates 58. A plurality of reinforcing ribs 65 extending vertically along side edges of plates 58. The longer sides of the plates 58 extend in the same direction as the direction of movement of the picker cart 40. As shown in FIG. 3, the reinforcing ribs 65 have a vertical extension over the length of the shorter sides of the plates 58. The number and positions of reinforcing ribs 65 and recesses 63 are determined by the size and weight of the packages 16. The orientation and direction of movement of the plates 58 also will facilitate a correction of a possible obliquity of the package in the storage line.

Each suction device 60 is supported by four hoisting belts 50, each hoisting belt being attached to different corners of the suction device and being wound up on a separate hoisting wheel 52. As shown in FIG. 4 the hoisting belts do not extend in parallel but are closer to each other where attached to the suction device than where they are wound up on hoisting wheels 52. As a result, swinging movements during lifting and lowering of a package are restricted.

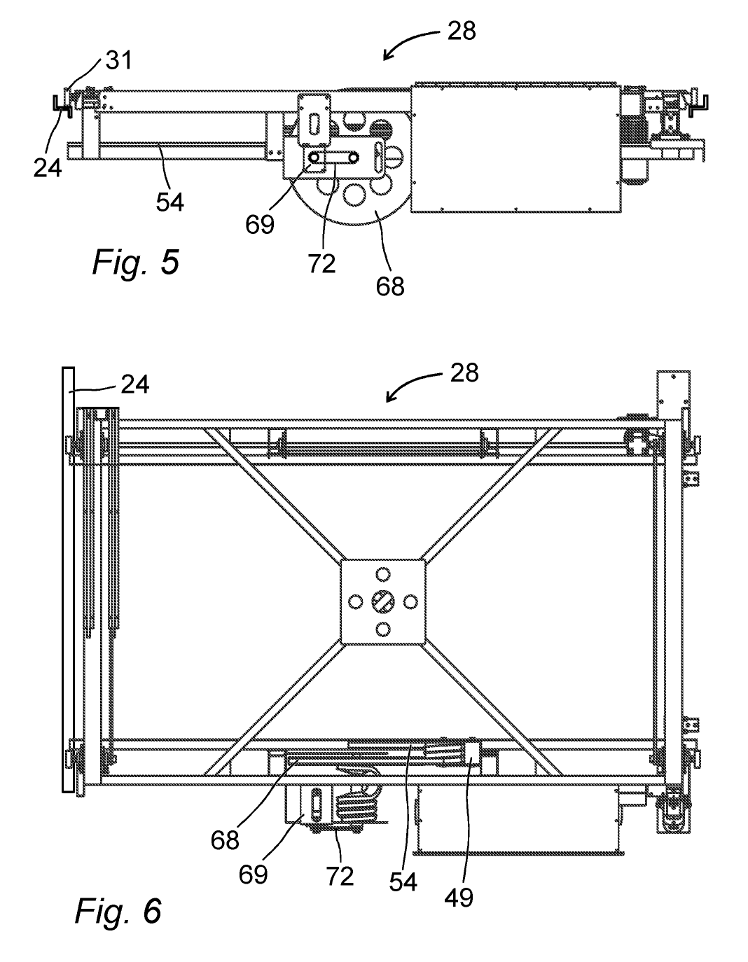

In the embodiment of a rectangular picker transfer cart 28 shown in FIG. 5 and FIG. 6 one cart wheel 31 is arranged in each corner. The cart wheels run on rails 24 extending along a picking aisle 19. Electrical power, compressed air and control signals are provided from the picker transfer cart 28 to the picker cart 40 through the control cable 54. The control cable 54 is wound up on a cable winder 68 which is driven by a cable motor 69 through a chain 72. The length of the control cable 54 corresponds to or extends the length of a storage line, so as to allow full operation of the picker cart 40 along the full length of a storage line. The control cable 54 is formed as a chain and may comprise pipes, fibres and different types of electrical cables. The cable motor 69 has a defined moment to ensure that the control cable 54 is properly stretched and that the picker cart 40 does not spin. The cable motor 69 is provided with a pulse transducer which is used to determine the movement and position of the picker cart 40.

The picker cart 40 shown in FIG. 7 has moved into an end position in a storage line 12 suspended from said top rail arrangement 30 in picker transfer cart 28 and from said suspension rail arrangement 32 in said storage line 12, rail only shown on one side in FIG. 7. The picker cart 40 runs on a plurality of support wheels 55. The picker transfer cart 28 runs in a similar way on cart wheels 31 supported on said rails 24. An electric motor 38 drives the wheels 55 through drive shafts 39. The electric motor 38 includes a gearbox. A chain drive (not shown) or similar drive means can be arranged between shafts 39 and between wheels 55.

The baseboard transfer cart 20, picker transfer carts 28 and the picker carts 40 are provided with communication means 41 communicating with a central unit 42. The central unit 42 comprises a processing unit 43, a communication device 44 and memory means 45. The power lines in the rails 24 can be used for communication between the central unit 42 and the baseboard transfer carts 20 and the picker transfer carts 28, respectively. Stationary data, such as dimensions, distances and performance of the multi-storey goods storage arrangement, carts and other units are stored in the memory means 45. Dynamic data relating to location and size of specific packages or goods, baseboard, speed of conveyors etc. are continuously received through the communication device 44 from carts and from a plurality of sensors and gauges arranged throughout the multi-storey goods storage arrangement. A control software running in the central unit continuously monitors and controls the function of the multi-storey goods storage arrangement. Information relating to different patterns or sets of packages is also stored and handled with the control software. As a result, any picked package can be positioned and monitored throughout the handling thereof within and out of the multi-storey goods storage arrangement.

In the embodiment of a picker cart 40 shown in FIG. 8 two lifting yokes 48 are supported on a common carriage 80. When the picker cart 40 is positioned in a storage line for picking up a package the carriage 80 is centred above a package by sliding the carriage 80 as indicated by arrow S. When the correct position has been reached either one or both of lifting yokes 48 are lowered until the suction plate 71 engages the package 16. Then the suction devices 60 are activated to be attached to the package 16. By activating the motor and gearbox 53 the hoisting belts 50 are wound up on the hoisting wheels 52 and the package is lifted.

When the package has been lifted to a position where a bottom side of the package is above the support sections 61 of the plates 58 linear motion drives 82 are activated to move the plates 58 in the direction of arrows B. During this movement side edges of the plates 58 will engage side edges of the package 16. As a result, the package 16 will rotate as indicated by arrow R and be aligned with the plates 58. This is advantageous because further handling of the package 16 will be facilitated when a correct orientation thereof is ensured.

In various embodiments the rails supporting the baseboard transfer cart 20 and the picker transfer carts 28 are provided with power lines supplying electrical power to the baseboard transfer cart 20 and the picker carts 40 through sliding contacts (not shown).

While certain illustrative embodiments of the invention have been described in particularity, it will be understood that various other modifications will be readily apparent to those skilled in the art without departing from the inventive concept. Accordingly, it is not intended that the scope of the claims appended hereto be limited to the description set forth herein but rather that the claims be construed as encompassing all equivalents of the present invention which are apparent to those skilled in the art to which the invention pertains.

1. A multi-storey goods storage arrangement comprising a plurality of levels of storage lines arranged in parallel, each storage line supporting a plurality of baseboards with packages, and transport aisles extending in parallel between opposing ends of sets said storage lines, wherein at least one baseboard transfer cart is operable along each transport aisle, wherein
picking aisles extending in parallel between opposing ends of sets said storage lines and in parallel with said transport aisles,
at least one picker transfer cart operating along each picking aisle, each picker transfer cart supporting at least one picker cart, a top rail arrangement on said picker transfer cart from which said picker cart is suspended,
a suspension rail arrangement in said storage lines corresponding to said top rail arrangement to allow said picker cart to move out from said picker transfer cart, into said storage lines while suspended from said suspension rail arrangement, said picker cart comprising lifting means arranged to lift a package stored in said storage lines and to transport lifted package to a picking aisle after returning said picker cart to said picker transfer cart, and
at least one first conveyor extending horizontally at each level and receiving packages from said at least one picking cart while supported on said picker transfer cart, wherein said lifting means comprises two lifting yokes suspended from said picking cart, each of said lifting yokes comprising a suction device having a surface to be firmly engaged to a package.

2. A multi-storey goods storage arrangement as claimed in claim 1, wherein
a locking device is arranged on said picker cart, said locking device extending below a lifted package to lock said package when lifted by said lifting yokes to a position adjacent to a bottom side of said picker cart.

3. A multi-storey goods storage arrangement as claimed in claim 2, wherein
said lifting yokes are connected to hoisting belts arranged on hoisting wheels driven by a motor and gearbox.

4. A multi-storey goods storage arrangement as claimed in claim 2, wherein
said suction device is electrically powered through a control cable connected to a power outlet on said picker transfer cart, and said control cable is formed as a chain.

5. A method of operating a multi-storey goods storage arrangement comprising a plurality of levels of storage lines arranged in parallel, each storage line supporting a plurality of baseboards with packages, and transport aisles extending in parallel between opposing ends of sets said storage lines, wherein at least one baseboard transfer cart is operable along each transport aisle, each baseboard transfer cart supporting at least one self-operated shuttle, wherein storing positions and present content of baseboards in a central unit,
operating a first conveyor at each level of said multi-storey goods storage arrangement,
said central unit directing a picker cart to pick up a package from a baseboard in a storage line and to suspend said package from said picker cart in at least one lifting yoke,
said central unit directing a picker transfer cart supporting said picker cart to a position over said first conveyor,
lowering said at least one lifting yoke until said package engages said first conveyor,
releasing said package on said first conveyor, and
storing in said central unit the position where the package is placed on said first conveyor.

6. A picker transfer cart arranged to move along picking aisles in a multi-storey goods storage arrangement comprising a plurality of levels of storage lines arranged in parallel, each storage line supporting a plurality of baseboards with packages, and
transport aisles extending in parallel between opposing ends of sets said storage lines, the picker transfer cart supporting at least one picker cart suspended from a top rail arrangement,
said picker cart comprising lifting means to lift a package stored in said storage lines and to transport lifted package to a picking aisle after returning said picker cart to said picker transfer cart, wherein said lifting means comprises two lifting yokes suspended from said picking cart, each of said lifting yokes comprising a suction device having a surface to be firmly engaged to a package, and wherein
a locking device is arranged on said picker cart, said locking device extending below a package to lock said package when lifted by said lifting yoke to a position adjacent to a bottom side of said picker cart, and said locking device comprising two vertically standing horizontally moveable rectangular plates arranged opposite each other in parallel at a common vertical level, each plate having a support section extending horizontally towards an opposing plate and supporting together a package.

7. A picker transfer cart as claimed in claim 6, wherein
said lifting yoke is connected to hoisting belts arranged on hoisting wheels driven by a motor and gearbox.

8. A picker transfer cart as claimed in claim 6, wherein
said suction device is electrically powered through control cable connected to a power outlet on said picker transfer cart, and
said control cable is formed as a chain.

9. A picker transfer cart as claimed in claim 6, wherein
said plates are arranged on sliding members mounted at a bottom side of said picker transfer cart.

10. A picker transfer cart as claimed in claim 9, wherein
said plates are connected to a linear motion drive arranged to move said plates towards and away from each other.

11. A picker transfer cart as claimed in claim 6, wherein
said lifting yokes are suspended in four hoisting belts, each hoisting belt being connected to a corner portion of a suction device and being wound up on four hoisting wheels arranged at an upper portion of the picker cart.
